(19) United States
(12) Patent Application Publication
(10) Pub. No.: US 2005/0200170 A1
(43) Pub. Date: Sep. 15, 2005

(54) Bike seat fixation

(75) Inventor: Hsueh-Sen Liao, Hsin-Chu Hsien (TW)

Correspondence Address: TROXELL LAW OFFICE PLLC, 5205 LEESBURG PIKE, SUITE 1404, FALLS CHURCH, VA, 22041, US

(73) Assignee: Hsin Lung Accessories Co., Ltd.

(21) Appl. No.: 11/023,564

(22) Filed: Dec. 29, 2004

(30) Foreign Application Priority Data
Feb. 27, 2004 (TW) 093202928

(51) Int. Cl. B62J 1/00

(52) U.S. Cl. 297/215.15

(57) ABSTRACT

A bike seat fixation means includes a pivoting ear being provided at the top of a seat post, two clips respectively locked with bolts to both sides of the pivoting ear; a lip with its opening laterally disposed being adapted to the top of each bracket to secure the seat to the seat post with a bolt; the angle of the seat being adjustable by loosening up the bolt securing the pivoting ear; and the lateral position of the seat, by loosening up the bolt securing the bracket.

### BACKGROUND OF THE INVENTION

(a) Field of the Invention

The present invention is related to a bike seat fixation means, and more particularly to one that allows adjustment of the angle of the seat as desired by the rider and the position of the seat in relation with the frame of the bike.

(b) Description of the Prior Art

Usually the seat of a bike is fixed to the top of a seat post to facilitate regulation by extension between the seat post and the frame to adjust the height of the seat. Therefore, a firm fixation means must be provided between the seat and the seat post. That is, the means must be capable of adjusting the angle or lateral position of the seat to allow the rider to adjust the seat for the optimal riding comfort as desired.

As illustrated in FIG. 1 of the accompanying drawings, a fixation means of the prior art disposed between the seat and the frame of bike that allows adjustment of the seat has two lateral levers 11 arranged in parallel at the bottom of the seat (not illustrated); a coupling member 20 is disposed to where both levers are provided; a seat post 30 extends upward from the frame of the bike (not illustrated); a joint 40 connecting to the coupling member 20 is provided at the top of the seat post 30; and two bolts 50 lock up both of the coupling member 20 and the joint 40 to each other to secure the seat to the seat post 30. Wherein, an upper bracket a lower bracket 21, 22 are provided on each side of the coupling member 20 to clamp both levers 11 to facilitate the locking force from both bolt 50 to compress the upper brackets 20 downward upon the lower brackets 21 to secure both levers in place while the entire coupling member 20 compresses against the joint 50 to couple the seat to the seat post and fix the angle of the seat.

However, the prior art is not practical as it is expected. When the angle of the seat alone is to be adjusted, the clamping force from the coupling member 20 against the levers must be released at the same time. As a result, both levers 11 and the coupling member 20 get loosened up to change the lateral position of the seat. Similarly, if only the lateral position of the seat is to be adjusted; the locking force between the coupling member 20 and the joint 40 must be released to cause both of the coupling member 20 and the joint 40 to get loosened up, thus further to change the angle of the seat.

### SUMMARY OF THE INVENTION

The primary purpose of the present invention is to provide a fixation means for the seat of a bike that while firmly securing the seat allows independent adjustment of the angle of the seat or the lateral position. To achieve the purpose, a pivoting ear is provided at the top of the seat post of the bike; two brackets are respectively locked to both sides of the pivoting ear; a lip is laterally provided on the top of each bracket to bite a lever disposed below the seat, and the opening is then locked with a bolt to form a firm fixation means for the seat.

Accordingly, when the bolt locking the pivoting ear is loosened up to adjust the angle of the seat, both brackets remain firmly clamping both levers without affecting the lateral position of the seat; on the contrary, when the bolts locking the brackets are loosened up for the purpose of moving the seat ahead or backward, the angle of the seat will not be affected for the present invention to allow adjustment of either the angle or the lateral position of the seat without affecting each other.

### BRIEF DESCRIPTION OF THE DRAWINGS

FIG. 1 is a perspective view of a fixation means of the prior art for the seat of a bike.

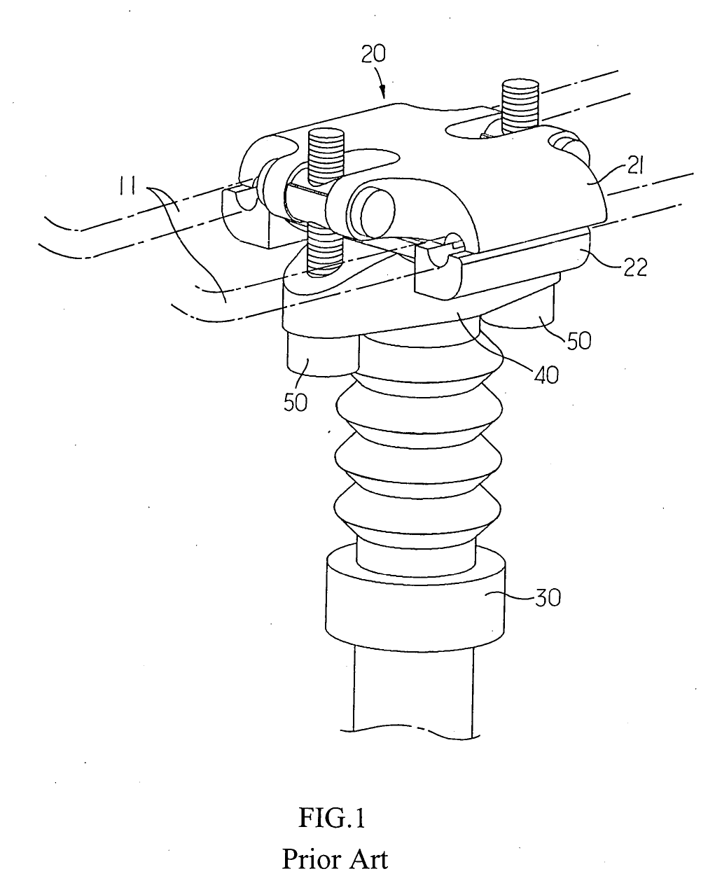

FIG. 2 is a perspective view of a first preferred embodiment of the present invention.

FIG. 3 is an exploded view of the first preferred embodiment of the present invention.

FIG. 4 is a sectional view of the first preferred embodiment of the present invention.

FIG. 5 is a schematic view showing adjustment of the angle of the seat in the present invention.

FIG. 6 is a schematic view showing adjustment of the lateral position of the seat in the present invention.

FIG. 7 is an exploded view of a second preferred embodiment of the present invention.

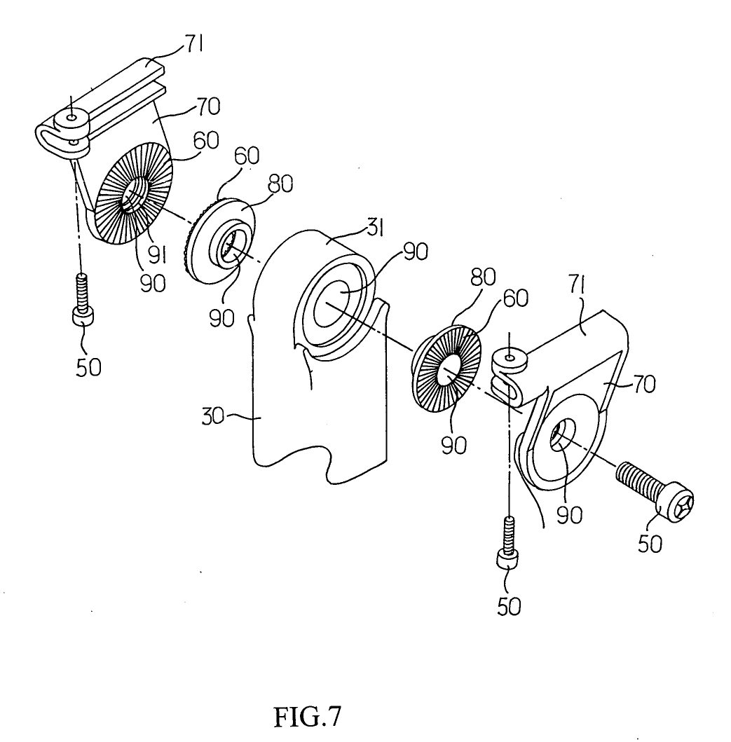

FIG. 8 is an exploded view of a third preferred embodiment of the present invention.

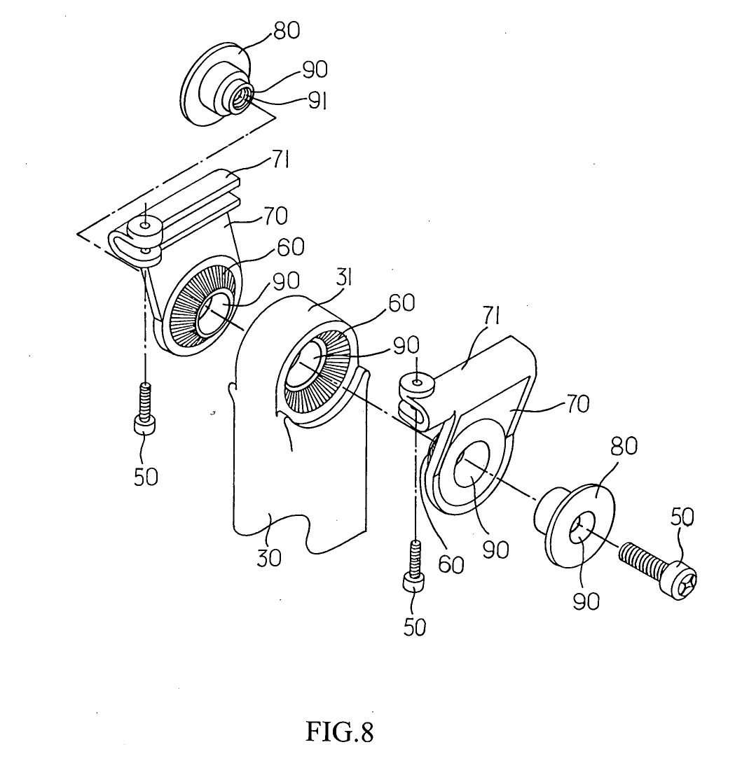

FIG. 9 is an exploded view of a fourth preferred embodiment of the present invention.

### DETAILED DESCRIPTION OF THE PREFERRED EMBODIMENTS

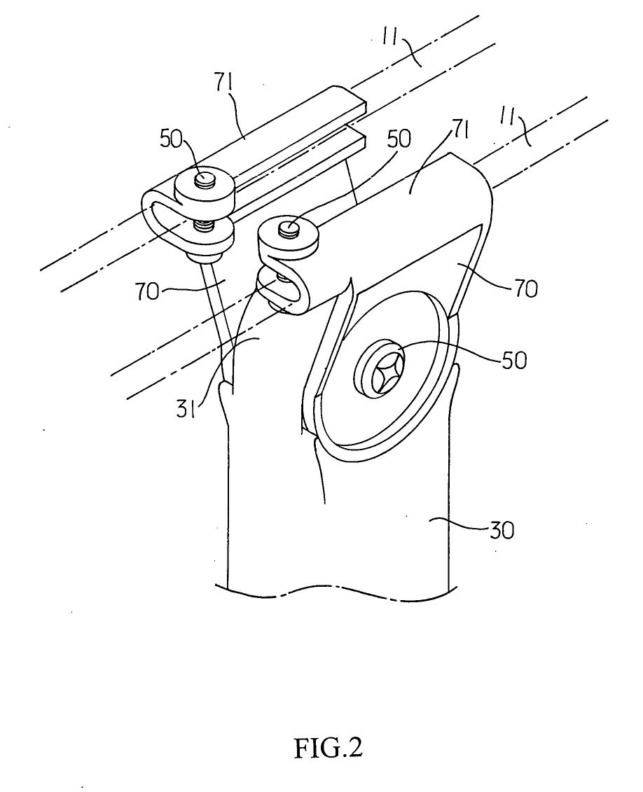

Referring to FIG. 2 for a first preferred embodiment of the present invention, a bike seat fixation means has two levers 11 arranged in parallel at the bottom of the seat (not illustrated); and a seat post 30 extends upward from a frame of the bike. The seat is coupled to the seat post 30 of the frame through both levers 11.

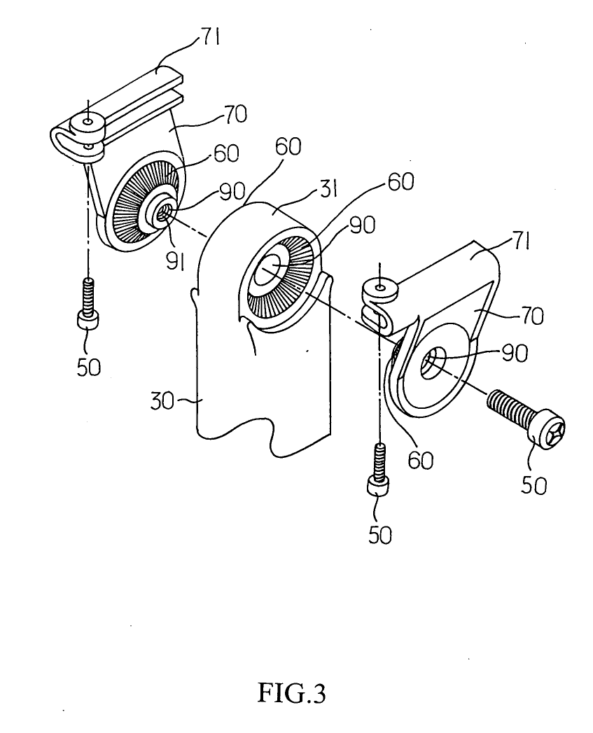

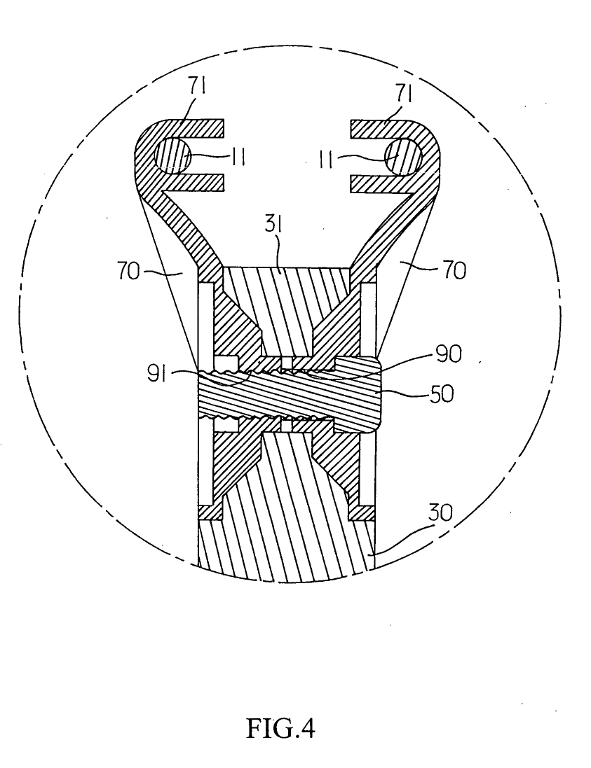

As illustrated in FIGS. 3 and 4, a pivoting ear 31 is disposed at the top of the seat post 30; and two brackets 70 are respectively locked with a bolt 50 to both sides of the pivoting ear. A lip 71 with its opening laterally disposed is provided at the top of each bracket 70 to bite the lever 11 and the lever 11 in the lip 71 is then locked up with a bolt 50 to form a firmly constructed seat fixation means.

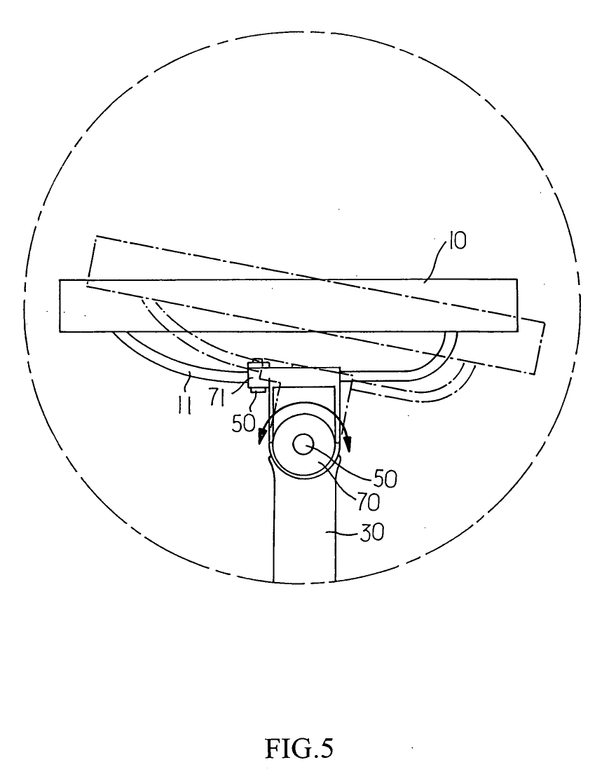

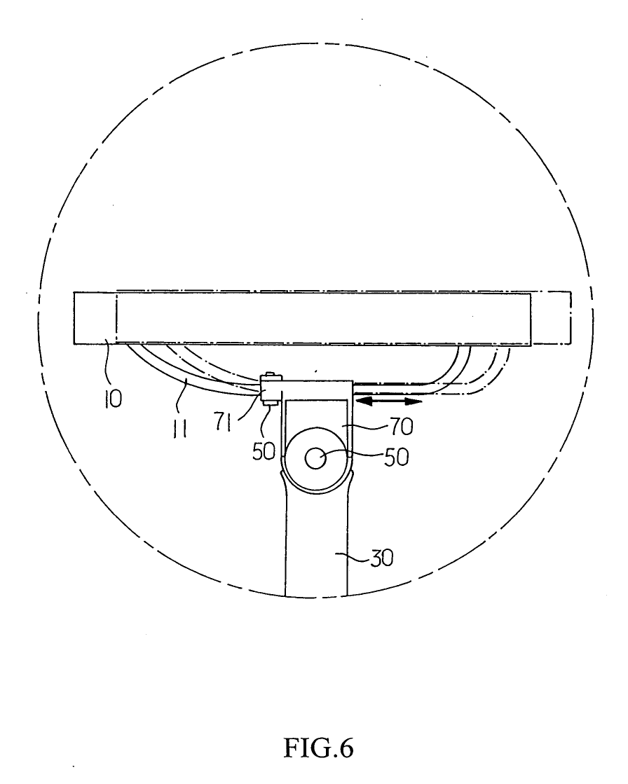

To adjust the angle of the seat, the bolt 50 locking the pivoting ear 31 is loosened up; or to adjust the lateral position of the seat, both bolts 51 locking the lips 71 are loosened up. As illustrated in FIG. 5, the bolt 50 locking the pivoting ear 31 is loosened up for the adjustment of the angle of a seat 10; meanwhile both levers 11 are firmly secured by their respective lips 71 without affecting the lateral position of the seat 10. On the contrary, if the adjustment of the lateral position of the seat 10 is desired as illustrated in FIG. 6, both bolts 50 locking up their respective levers 11 in the lips 71 are loosened up for the adjustment without affecting the angle of the seat 10. Accordingly, the present invention allows the adjustment of the angle of the seat or the lateral position of the seat without affecting each other.

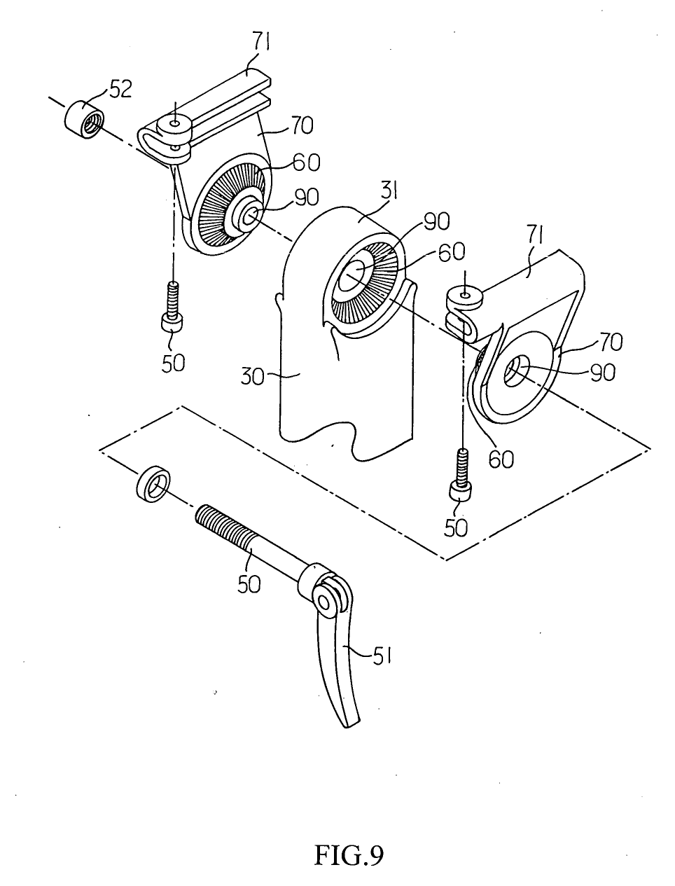

As illustrated in FIGS. 3 and 4, a through hole 90 is each provided on the pivoting ear 31 and on both brackets 70. The through hole 90 on one bracket 71 is provided with a thread 91 to be engaged with the bolt 50. The contact surfaces between the pivoting ear 31 and each bracket 70 are each provided with a thread 60 to secure the angle of the seat by restricting the displacement due to friction between the bracket 70 and the pivoting ear 31. A ring packing 80 is provided between the bolt 50 and the bracket 70 as illustrated in FIG. 80 to improve the suppression effect of the bolt against the bracket 70; or alternatively, as illustrated in FIG. 9, a cam wrench 51 is pivoted to the edge of the head of the bolt locking the pivoting ear 31 with the head fully penetrating into the through hole provided on the other bracket; and a nut 52 is provided on the tail of the bolt 50. The suppression provided by the cam wrench 51 secures both brackets 70 to the pivoting ear 31 to achieve the purpose of fast release or fastening of the bolt 50.

The prevent invention provides an improved construction of a bike seat fixation means, and the application for a utility patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

1. A bike seat fixation means includes a seat coupled to a seat post extending from a frame of the bike through two levers arranged in parallel to each other provided below the seat; the seat post having at its top disposed with a pivoting ear, and two brackets being respectively locked each with a bolt on both sides of the pivoting ear; a lip with its opening laterally disposed being adapted to the top of each bracket; each lip biting a lever; a bolt locking up the lip; seat angle being adjustable by loosening the bolt locking the pivoting ear; and lateral position of the seat in relation to the frame of the bike being adjustable by loosening the bolt locking the bracket.

2. The bike seat fixation means of claim 1, wherein the surfaces where the pivoting ear and the bracket meet are respectively threaded to engage with each other.

3. The bike seat fixation means of claim 1, wherein a ring packing is provided between the pivoting ear and the bracket.

4. The bike seat fixation means of claim 3, wherein the surfaces where the ring packing and the pivoting ear meet are respectively threaded to engage with each other.

5. The bike seat fixation means of claim 3, wherein the surfaces where the ring packing and the bracket ear meet are respectively threaded to engage with each other.

6. The bike seat fixation means of claim 1, wherein a ring packing being provided between the bolt locking the pivoting ear and both brackets respectively.

7. The bike seat fixation means of claim 1, wherein a through hole is each disposed in the pivoting ear and both brackets, a bolt being permitted to penetrate into all those through holes; and the through hole of either of both brackets is provided with a screwed hole.

8. The bike seat fixation means of claim 1, wherein a through hole is each disposed in the pivoting ear and both brackets, a bolt being permitted to penetrate into all those through holes; the through hole of either of both brackets is provided with a screwed hole; a cam wrench being pivoted to the head of the bolt to compress and firmly fasten the pivoting ear and both brackets.
